(19) United States
(12) Patent Application Publication
(10) Pub. No.: US 2013/0080287 A1
(43) Pub. Date: Mar. 28, 2013

(54) VIRTUAL DOLL BUILDER

(71) Applicant: SDI Technologies, Inc., Rahway, NJ (US)

(72) Inventors: Craig Currie, Rahway, NJ (US); Leon Cohen, Rahway, NJ (US); Marc Chrem, Rahway, NJ (US); Isaac Ashkenazi, Rahway, NJ (US)

(73) Assignee: SDI Technologies, Inc., Rahway, NJ (US)

(21) Appl. No.: 13/623,000

(22) Filed: Sep. 19, 2012

Related U.S. Application Data
(60) Provisional application No. 61/536,348, filed on Sep. 19, 2011.

(51) Int. Cl. G06Q 30/06; G06Q 30/02

(52) U.S. Cl. CPC G06Q 30/0621
USPC 705/26.5

(57) ABSTRACT

The systems and methods of the present solution include a streamlined and simplified website by which users can create their dolls. A simple multi-page process guides the client through, with lots of fun moments and a very basic check-out system. In some embodiments, a dress-up portion of the creation process and/or activity/game may allow visitors to explore and see what their dolls look like with various clothes and accessories, and provides an element of fun and excitement around what they have created, and adds value to the site that does not detract or distract from the main goal of converting to purchase

### RELATED APPLICATION

The present application claims the benefit of and priority to U.S. Provisional Application No. 61/536,348, entitled “The Virtual Doll Builder” and filed on Sep. 19, 2011, which is incorporated herein by reference in its entirety for all purposes.

### FIELD OF THE DISCLOSURE

The present disclosure relates generally to the field of virtual doll building, and more particularly, to enhancing an online virtual doll building and ordering experience.

### BACKGROUND

Conventional systems for online doll ordering are limited to selecting a complete doll from multiple dolls online via a website. Although the user may select from various dolls, the user does not typically get to customize any of the specific features of a selected doll. The doll's facial features are predetermined based on the selected online item. As such, a doll buyer is not able to get a doll with desired facial features.

### SUMMARY

The doll creation and purchasing application of the present solution provides an experience that is all about getting a high quality, highly customized doll to fit the user's needs. The website's clientele may include children, and the website lets them create a doll that can become their best friend forever (BFF). In some cases, the goal is to provide a simple but powerful doll creation website or micro-site that children can use to set up their doll, and then allow them to purchase that doll (with their parent's help as needed). Beyond that, the web site is designed for those customers and have them frequent the website to socialize, play games, and browse other items.

In some aspects, the systems and methods of the present solution include a streamlined and simplified website by which users can create their dolls. A simple multi-page process guides the client through, with lots of fun moments and a very basic check-out system. In some embodiments, a dress-up portion of the creation process and/or activity/game may allow visitors to explore and see what their dolls look like with various clothes and accessories, and provides an element of fun and excitement around what they have created, and adds value to the site that does not detract or distract from the main goal of converting to purchase.

In further aspects, a child's doll may be translated into an avatar for the website, with whom the child can choose to play games with from a suite provided. Games may be breezy and fun and will typically pit the player against their BFF in light competition in an effort to build a bond between them.

A doll creator portion of the website may be the first point of contact. This site may be designed with the target audience in mind, of which may be users that are young children, and so the goal is to keep the experience light and fun as much as possible. Creating the doll is almost like a game, and purchasing should be fast and easy, with a parent's help needed only for the purchase portion.

Before a child moves straight to the look and components of their doll, they may take a short quiz about themselves and their BFF (3-5 questions). Questions like “Which do you like best? a) Dancing b) Sports c) Music d) Animals” or “Your friends are best described as: a) Athletic b) Funny c) Smart d) Creative” will give us broad guidelines from which to model the user and their doll. These guidelines will be used to pre-model the user's doll towards their preference, as well as to tailor messaging “from the BFF” later in the process.

Once profiling is complete, the CREATION SCREEN may be revealed behind it. Front and center will be a rendering of the user's doll, with some options already prefilled to reflect the user's answers for the profiling questions. As they make changes, this rendering will reflect them so they can see their changes take effect immediately and evaluate them. Creators will choose from a series of preset options for their dolls, ranging from hair to skin color to outfits and accessories. Users will also be asked to name their doll and fill out a little more “personal information” about the character they are creating. Does the doll like going to school? Who are the doll's friends? What are its favorite foods? All of these and more begin to personify the doll and make it more real to the child. This also helps to bridge the gap as we make the doll into an avatar for use throughout the rest of the website.

The CREATION SCREEN will allow manipulation of the following components:
FACE: As a user makes changes to the doll's face, the rendering will pull in tight on the face so that the changes can be seen in detail.
OUTFIT: The outfit will default to something that matches the child's preferences, and will be limited to a few presets instead of letting the child choose every last detail.
ACCESSORIES: A few accessories will be prefilled to match the child's preferences, but many more will be available.
NAME: The child will be required to name the doll.
BIRTHDAY: the BFF birthday would default to the day of her creation, but can be changed.
ROOM: A doll needs to live somewhere, right? The final step will be for the user to choose a Room style for their BFF (sporty, artistic, ballerina, jungle, etc). The Room is basically just a background placed behind the BFF whenever they're rendered at home.

Once a child is happy with their doll and wants to buy it, there may be another step to take. Children may not be allowed to purchase dolls directly, but may have to do so through their parents. As such, when they are done with their doll and want to BUY, the application will pop up a dialog that allows the child to input their parent's, grandparent's, aunt's, uncle's, or other relative's email address. The family member will receive an email that contains a short greeting, rendering of the doll their child or relative created (as an attachment PDF), and a link back to the website where the doll may be purchased directly.

In some embodiments, the web site may build excitement before the doll arrives. Once a child (such as a girl) has built a BFF, the confirmation email may come in two parts. The first is a simple order confirmation, which may go to the parents. In addition to that, an email from the BFF itself may be sent to the child. This may be intended to get the child excited for the arrival for their doll, as well building the personality of the doll and starting the child towards personifying it. For example:
Hi Janie!
I'm on my way to your house now, I can't wait for all the fun times we'll have together!
Your BFF,
Melissa

In some embodiments, the doll creation tool comprises a dress-up component or screen to add, change or configure clothing and/or accessories for the doll and to visualize the clothing and/or accessories on the doll. In some other embodiments, to complement the doll creation tool, the website may also have a doll dress-up game for users to experiment with. The game can be used in two ways: first, as a straight dress-up game with generic options for characters and clothing. A user will not have to create a doll to access the game in this way. The second way is using a saved doll as your character, with clothing options appropriate to that doll's characteristics. In some embodiments, via the creation process, the user may be able to dress up their virtual doll with clothing and/or accessories. In other embodiments, users may be encouraged to take their newly created dolls made on the CREATION SCREEN and immediately begin tinkering with them in the dress-up game.

In the game, players may choose between the different apparel options to adorn their character. In addition to this, a wide range of accessories are included like scarves, headbands, jewelry, hats and shoes. Accompanying the game play is a suite of optimistic messaging, as the game gives players positive feedback and commentary about their look and their decisions.

Once a doll is purchased, the doll may be translated into an avatar. In other cases, a user may create or purchase an avatar without purchasing the doll. The face may be made into an icon and the doll may act like an Artificial Intelligent (AI) personality on the site. This is the user's BFF . . . their best friend forever with whom they can now explore the site and play games together with. These BFFs will have names, characteristics, personalities, and will similarly act as guides for the young user through what the rest of the website has to offer.

When a doll has been purchased and made into an avatar, it's time to take your new BFF out for a spin! The website may provide a platform for playing games for users with dedicated accounts. The website may provide a dedicated Games section to the website, from which users can select and play any that are offered. The website may have engines that can offer a variety of games to play with and against a child's new friend. In some embodiments, games may include ones where the doll avatar could play an active role, with some amount of competition between the child and the avatar.

In some aspects, the present invention is directed to a method for creating and purchasing a customized doll via a website. The method includes displaying, via the website operating on one or more servers, a rendering of a user's doll created by a user via the website, such as via a creation tool provided by the website. The method further includes receiving, by the website from the user, a selection of one or more options to change one or more appearance features of the user's doll and changing, via the website, the rendering of the user's doll based on the selection. The method also includes receiving, via the website, a request to purchase the user's doll created via the website. The method may further includes manufacturing the user's doll to correspond to the rendition of the user's doll on the website.

In some embodiments, the method includes displaying a pre-model of the user's doll having appearance features based on preferences identified via a profile of the user. In some embodiments, the method includes communicating, via the website, a creation screen or tool for the user to select options for one or more of the following: outfit, accessories, name, birthday or a room. In some embodiments, the method includes receiving, via the website, a selection of one or more options to change a skin color of the user's doll. In some embodiments, the method includes receiving, via the website, a selection of one or more options to change one of a hair color and hair style of the user's doll. In some embodiments, the method includes receiving, via the website, a selection of one or more options to change an eye color of the user's doll. In some embodiments, the method includes receiving, via the website, a selection of one or more options to change one of makeup or freckles of the user's doll.

In some embodiments, the method includes generating, via the web-site, an avatar corresponding to the user's doll. In some embodiments, the method includes providing, via the web-site, an online community that the user can interact with via the avatar.

In some aspects, the present invention is directed to a system for creating and purchasing a customized doll via a website. The system may include a website operating on one or more servers and providing a user interface for creating a doll by a user. The system may also include a creation tool to display a rendering of the user's doll. The creation tool receives a selection of the one or more options to change one or more appearance features of the user's doll and changes the rendering of the user's doll based on the selection. The system also includes an ordering interface to receive a request to purchase the user's doll created via the website. In some embodiments the ordering interface communicates information on the user's doll to manufacture the user's doll to correspond to the rendition of the user's doll on the website.

In some embodiments, the creation tool displays a pre-model of the user's doll having appearance features based on preferences identified via a profile of the user. In some embodiments the creation tool provides an interface for the user to select options for one or more of the following: outfit, accessories, name, birthday or a room. In some embodiments the creation tool receives a selection of one or more options to change a skin color of the user's doll. In some embodiments, the creation tool receives a selection of one or more options to change one of a hair color and hair style of the user's doll. In some embodiments the creation tool receives a selection of one or more options to change an eye color of the user's doll. In some embodiments, the creation tool receives a selection of one or more options to change one of makeup or freckles of the user's doll.

In some embodiments, the web-site generates an avatar corresponding to the user's doll. In some embodiments, the web-site further comprises an online community that the user can interact with via the avatar.

In some aspects, the present invention is directed to a method for creating and purchasing a doll via a website based on a user profile. The method may include receiving, by a website operating on one or more servers, responses from a user to a list of questions to profile the user for creating a doll and displaying, via the website, a rendering of the user's doll based on a profile of the user. The method may also include receiving, by the website from the user, a selection of one or more options to manipulate one or more appearance features of the user's doll and changing, via the website, the rendering of the user's doll based on the selection. The method may further include receiving, via the website, a request to purchase the user's doll created via the website.

In some embodiments, the method includes communicating, via the website to the user, the list of questions, the responses to the list of questions providing guidelines to model the user's doll. In some embodiments, the method includes creating the profile of the user from the responses to the list of questions. In some embodiments, the method includes generating a pre-model of the user's doll having appearance features based on preferences identified via the profile of the user. In some embodiments, the method includes communicating, via the website, a creation screen for the user to manipulate the face of the user's doll. In some embodiments, the method includes communicating, via the website, a creation screen for the user to select or change one or more of the following: outfit, accessories, name, birthday or a room. In some embodiments, the method includes receiving, via the website, a selection of one or more options to change a skin color of the user's doll. In some embodiments, the method includes receiving, via the website, a selection of one or more options to change a hair color of the user's doll. In some embodiments, the method includes receiving, via the website, a selection of one or more options to change an eye color of the user's doll. In some embodiments, the method includes receiving, via the website, a selection of one or more options to change a shape of a feature of the user's doll. In some embodiments, to change the shape of a feature the user chooses or selects a different selection or options for that feature. In some embodiments, the method includes receiving, via the website, a selection of one or more options to change a size of a feature of the user's doll. In some embodiments, the method includes manufacturing the user's doll corresponding to the rendition of the user's doll on the website.

In some aspects, the present invention is directed to a system for creating and purchasing a doll via a website based on a user profile. The system includes website operating on one or more servers. The website provides a user interface for creating a doll by a user. The system includes a profiler receiving responses from the user to a list of questions to create a profile of the user and a creation tool displaying a rendering of the user's doll based on a profile of the user and one or more options to manipulate one or more appearance features of the user's doll. The creation tool receives a selection of the one or more options and changes the rendering of the user's doll based on the selection. The system also includes an ordering interface that receives a request to purchase the user's doll created via the website.

In some embodiments, the creation tool generates a pre-model of the user's doll having appearance features based on preferences identified via the profile of the user. In some embodiments, the creation tool provides an interface for the user to manipulate one or more of the following: outfit, accessories, name, birthday or a room. In some embodiments, the creation tool receives a selection of one or more options to change a skin color of the user's doll. In some embodiments, the creation tool receives a selection of one or more options to change a hair color of the user's doll. In some embodiments, the creation tool receives a selection of one or more options to change an eye color of the user's doll. In some embodiments, the creation tool receives a selection of one or more options to change a shape of a feature of the user's doll or select a new option for the feature. In some embodiments, the creation tool receives a selection of one or more options to change a size of a feature of the user's doll.

### BRIEF DESCRIPTION OF THE DRAWINGS

FIG. 1 is a block diagram of an embodiment of a network environment for a client to access a server via a network;

FIG. 2 is a block diagram of an embodiment for processing communications between a client and a server;

FIG. 3 is a block diagram of a system in accordance with a described embodiment;

FIG. 4 is a flow diagram of a method in accordance with a described embodiment;

FIGS. 5A-5F illustrate a website in accordance with described embodiments; and

FIG. 6 illustrates an embodiment of avatars used in online communities.

### DETAILED DESCRIPTION

A. Network and Computing Environment

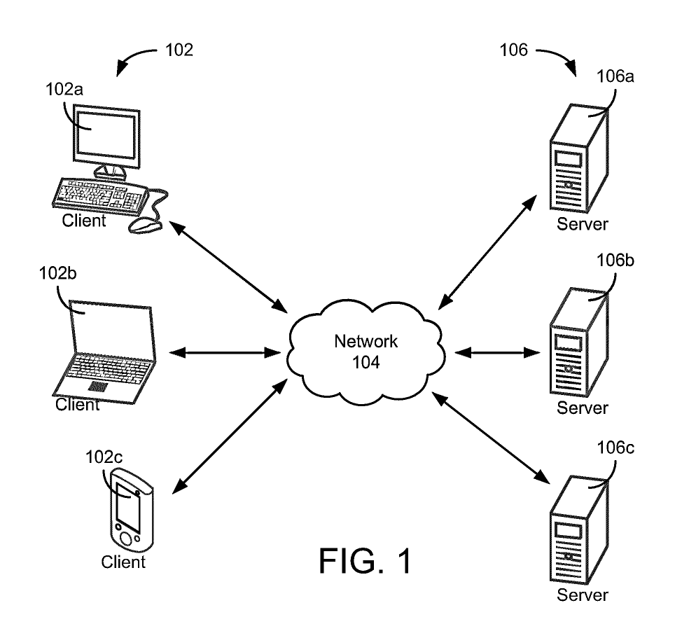

Prior to discussing the specifics of embodiments of the systems and methods of the present solution, it may be helpful to discuss the network and computing environments in which such embodiments may be deployed. Referring to FIG. 1, an embodiment of a network environment is shown. In a general overview, the network environment may have one or more clients 102a-102c (generally referred to as client(s)102) in communication with one or more servers 106a-106c (generally referred to as server(s)106) via a network 104. The clients may communicate with a server via any type and form of communications or communication path.

The network 104 be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein.

The network 104 is shown between the clients 102 and the servers 106. In some embodiments, the clients 102 and the servers 106 are located on the same network 104. The network 104 may be a LAN, WAN, metropolitan area network (MAN), global area network (GAN), cellular network, etc. In some embodiments, the network 104 includes the Internet. The network may be a private or public network.

In some embodiment, the communication path between a client and a server is configured to implement a wide area network (WAN) configuration. The WAN may be used to connect the servers on a first local area network (LAN) with the clients on a second LAN. The WAN may further provide communication between the LAN and the Internet or World Wide Web.

The clients 102 may comprise any type and form of computing device including but not limited to a desktop computing device 102a, laptop computing device 102b, and a mobile computing device 102c. Each of the computing devices 102a-102c may include a corresponding network interface system or service, which represent different systems and methods for communicating with the servers 106a-106c. For example, the desktop computer 102a may use a telephone dialup or other lower speed device for Internet access, the laptop computer 102b may use a cable modem, digital subscriber line (DSL), or other high speed device for Internet access, and mobile device 102c may use a wireless device (e.g., cellular radio telephone, Wi-fi access point, etc.) for Internet access. These or other computing devices may each use one or more network interface systems or services

The client 102 may include a computing environment for executing an application that uses or processes a data file. The client 102 via network 104 may request an application and data file from the server 106. In some embodiments, the clients 102 may execute any application or system that accesses data made available by a server 106. In some embodiments, the client 102 communicates with the server 106. The client 102 may communicate directly with a server 106. In another embodiment, the client 102 may execute an application to communicate with a server 106. In some embodiments, the client 102 may communicate with the server 106 via the network 104. In some embodiments, the client may request execution of application(s) by the server 106. In some embodiments, the client 102 may receive and/or retrieve the output of the application. In some embodiments, the client 102 may display the output of the application.

In some embodiments, the client 102 may comprise an application for any of the embodiments of virtual doll building described herein. The client may be a mobile device that executes a mobile application, often referred to as a mobile app or app. The app may provide the user an interface on the mobile device to perform any of the system, methods and functions described herein. The app may communicate with any one or servers to perform any of the virtual doll building related functions, order any virtual doll and/or interact with an online community related to the virtual doll.

Servers 106 are configured to communicate via network 104 with one or more clients 102. In some embodiments, the servers 106 may operate at a single physical location or at different physical locations, which may be different buildings, states, or countries. In some embodiments, the servers 106 may include a database. The server 106 may access the database through a direct connection or via another network 104. The database may include a plurality of databases that may be organized into multiple tiers for data management and access. The database may utilize various technologies and formats including a relational database, tables, files, etc.

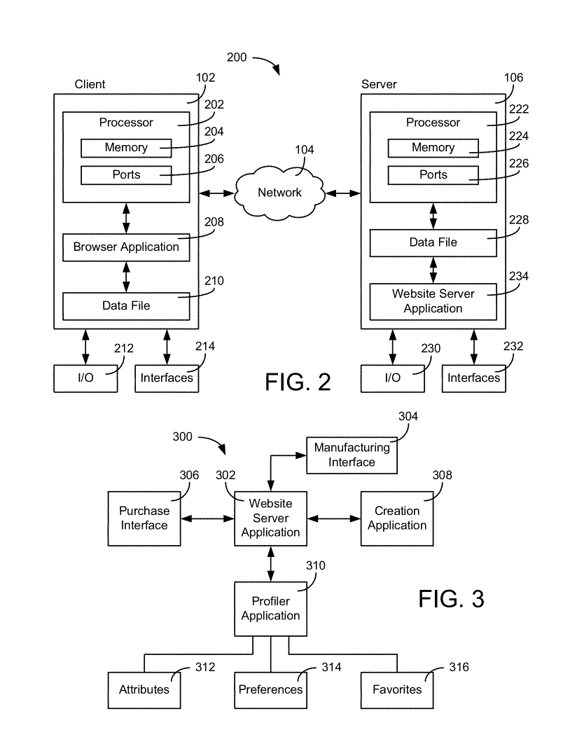

Referring to FIG. 2, a block diagram of an embodiment of a system 200 for processing and communications between a client and a server is shown. In a brief overview, the system 200 may include a client 102 in communication with a server 107 via a network 104. A client device 102 may include a processor 202, memory 204 and ports 206. The client may execute a browser application 208 and may store a data file 210 to a storage component or device of the client. The client may have any type and form of Input/Output (I/O) interface 212 and any type and form of network interface 214. A server device 106 may include a processor 222, memory 224 and ports 226. The server may execute a web application 234 and may store and serve a data file 228, such as from a storage component or device of the server. The server may have any type and form of Input/Output (I/O) interfaces 230 and any type and form of network interfaces 232.

The server 106 may execute a website server application 234 for providing systems and methods described herein. The server may server content, web pages, data files, etc from the application 234 to the client 102. The browser application 208 of the client 102 may receive content, pages or data file 228 from the website server application 234 of the server. In some embodiments, the client 102 may provide a data file 210 to the website server application 234. In some embodiments, the client 102 may provide a date file 210 to the browser application 208. In this embodiment, the browser application 208 may provide the data file 210 to the server 106.

In some embodiments, the client 102 and server 106 include one or more processors 202, 222 having a memory 204, 224 for storing or holding instructions executed by the one or more processors 202, 222 and ports 206, 226, input/output (I/O) ports 212, 230 and interfaces 214, 232. The client 102 may further include a browser application 208 and a data file 210, while the server may further include a facial recognition application (and a data file).

The processor 202, 222 may be configured (by hardware, software, or both) to perform functions described herein. In some embodiments, the processor 202, 222 transmits information to the I/O 212, 230 or interfaces 214, 232. In some embodiments, one processor 202, 222 may be used in the client 102 or the server 106. In some embodiments, multiple processors 202, 222 may be used. In the embodiments involving multiple processors 202, 222, the processors 202, 222 may be in the same client 102 or same server 106. In other embodiments, the processors 202, 222 may be distributed among a network 104 of clients 102, server(s) 106, and/or other devices.

In some embodiments, the memory 204, 224 is any non-transient data storage device that can store data which can thereafter be read by a computing device, such as the client or server. Examples of the memory 204, 224 include, but are not limited to, read-only memory (ROM), random-access memory (RAM), CD-ROMs, DVDs, electrically erasable programmable read-only memory (EEPROM), erasable programmable read-only memory (EPROM), field programmable gate array (FPGA), flash memory, compact disk, magnetic tape, magnetic disk, and other magnetic storage devices, and optical data-storage devices, etc. In some embodiments, the memory 204, 224 is distributed over network-coupled systems so that the software is stored and executed in a distributed fashion. In various embodiments, the non-transient memory 204, 224 includes volatile memory, non-volatile memory, and/or combinations of volatile and non-volatile memory.

In some embodiments, the browser application 208 may be any application that processes data to provide or display output to the client 102. The browser application 208 may access information from a server 106, the Internet, or other computer via a network 104. In some embodiments, the browser application 208 may access an application file from a server 106. The browser application 208 may download, install or store the application file in its local data file 210. This embodiment allows offline use of the browser application 208.

In some embodiments, the data file 210 stores data for use by the browser application 208. The data file 210 may be used for executing the browser application 208 and other application that uses or processes a data file 210. In some embodiments, the client 102 may not have the data file 210 stored or accessible locally. In response, the server 106 may transmit the data file 210 to the client 102. In some embodiments, the data files 210 may be compiled into a database. The data file 210 may also be used for input, output or other information for use by other software. The data file 210 may be provided to the I/O ports 212 and/or interfaces 214.

In some embodiments, the server 106 includes a website server application 234. The website server application may use or process the data file 210. The website server application 234 may also transmit a data file 228 to be executed by the browser application 208. The client 102 may request the website server application 234 from the server 106 via the browser application 208.

I/O ports 212, 230 and interfaces 214, 232 may be used to provide and receive data between the client 102 and other client computers, the client 102 and the server 106, the server 106 and other server computers, peripheral devices and other devices or components. The I/O ports 212, 230 and interfaces 214, 232 may also be used to provide and receive data between the client 102 and the servers 106 or the client and the network. The interfaces 214, 232 may include hardware/software interfaces, user interfaces (e.g., graphical user interface, command line interfaces, etc.), communication interfaces, network interfaces, etc. The I/O ports 212, 232 connect the client 102 to I/O devices and peripherals (e.g., keyboard, joystick, mouse, monitors, printers, modems, network cards, etc.)

B. Systems and Methods For A Virtual Doll/Avatar Building System and Communities

Referring to FIGS. 3-5F, systems and methods for online custom doll design, purchasing and manufacturing will be discussed. The present solution offers a custom doll designer tool that allows users to design multiple dimensions or characteristics of the doll, including but not limited to the face, skin, eyes, makeup, hair style, hair color, clothes and accessories. The user can order the custom doll for purchase and the custom doll will be manufactured and shipped to the user.

The experience offered via embodiments of the present solution is directed to getting a high quality, highly customized doll to fit the user's needs. In some aspects, the goal is to provide a simple but powerful doll creation microsite that children, such as, in some embodiments, young children ages can use to set up their doll, and then allow them to purchase that doll (with their parent's help). The website application and experience is to be designed and constructed to retain those customers and have them frequent the website to socialize, play games, and browse other items.

The custom doll designing tool or website may be streamlined and simplified website by which user can create their dolls. In some embodiments, a simple multi-page process guides the client through, with lots of fun moments and a very basic check-out system. In some embodiments, the design tool includes a dress-up component or screens to dress the doll with clothes and/or accessories. In other embodiments, a dress-up activity/game may allow visitors to explore and see what their dolls look like with various clothes and accessories, in different environments and backgrounds and provides an element of fun and excitement around what they have created, and add value to the site that does not detract or distract from a goal of converting to purchase.

In some embodiments, a child's doll is translated into an avatar, sometimes referred to as BFF (best friend forever) for the website, with whom the child can choose to play games with via the website. The website may provide games that are breezy and fun and may typically pit the player against their BFF in light competition in an effort to build a bond between the player/user and their BFF.

Referring now to FIG. 3, a block diagram of an embodiment of a system for virtual doll building and ordering is depicted. In brief overview, the system may include a website application 234 for providing an interface and the functionality for designing and ordering a customized doll based on a virtual doll created via the virtual doll building tools. The website application may include, interface to or communicate with a profiler application 302 to create a profile of the user, or user profile, that may comprise attributes 312, preferences 314, and favorites 316. The website application may include, interface to or communicate with a creation application or tool 308 for creating or configuring a custom doll by a user. The website application may include, interface to or communicate with a purchase interface 306 for a user to select, order and purchase a doll configured or created via the creation tool 308. The website application may communicate information on the customized doll via a manufacturing interface 304 so that a doll manufacturing can create, build or manufacture the doll according to the user's customization. The manufactured doll may be shipped to the user.

The website server application 234, sometimes referred to as a website or website application, may operate on one or more servers. The website application may comprise an application, program, library, script, process, services, task or other types and forms of executable instructions executable on a device. In some embodiments, the website application may comprise the purchase interface, the creation application, the profiler application and/or the manufacturing interface. In some embodiments, the website application may interface to or communicate with executable instances of the purchase interface, the creation application, the profiler application and/or the manufacturing interface operating on the same server or separate servers.

The website server application may provide a user interface for a user to access the functionality described herein (e.g., creating a doll by the user), such as via a browser over a network. The user interface may be a graphical user interface or a text-based interface. The website application may provide a plurality of user interface to present, interface to or provide access to any of the functionality of the purchase interface, the creation application, the profiler application and/or the manufacturing interface. The website application may include functionality for a user to register on the site and log on to the site via authentication of a user id and password.

The profiler application 302, sometimes generally referred to as a profiler, may comprise an application, program, library, script, process, services, task or other types and forms of executable instructions executable on a device. The profiler may comprise functions or operations for creating a profile for a user. The profiler may be a file, a program, a hyperlink, or other content that is provided to the client device, such as a web page served to a browser by the web application. The profiler may receive input for a profile from a user via a user interface. The profiler may provide a list of questions, survey or questionnaire to a user. The profile may provide a user interface for a user to input in any manner one or more attributes 312, preferences 314 and favorites 316. The profiler may receive responses from a user to a list of questions to create the profile of the user. The profiler may receive input for a profile for a user from information stored in a file, such as a cookie.

The profile application 302 may determine or create a user profile using any combination of attributes 312, preferences 314 and favorites 316. The attributes may comprise a characteristic of the user. The attributes may comprise a characteristic of a doll desired or to be customized/created by the user. The preferences may comprise a liking of one thing over another, such as certain characteristics of a doll. The preferences may comprise a liking of one activity of the user over another activity. The preferences may comprise a liking of one item of over another item. Favorites may be a person or thing that is well liked by the user, such as a favorite food, item, activity, sport person, color, style, fashion, accessory, etc.

Before a user moves to the look and components of their doll via the creation tool, in some embodiments, the user may takes a short quiz, for example 3-5 questions, about themselves and their BFF via a user interface of the profiler. Questions like “Which do you like best? a) Dancing b) Sports c) Music d) Animals” or “Your friends are best described as: a) Athletic b) Funny c) Smart d) Creative” may provide guidelines from which to model the user and their doll. These guidelines may be used to pre-model the user's doll towards their preference, as well as to tailor messaging “from the BFF” later in the process.

From the profile of the user, the web application via the profile application and/or creation application may generate pre-model or first model of the user's doll, avatar or pet. For example, the profile application 302 may generate a pre-model of the user's doll, avatar or pet having appearance features based on attributes 312 (such as female, male, birth date, etc.) identified via the profile of the user. In another example, the profile application 302 may generate a pre-model of the user's doll, avatar or pet having appearance features based on preferences 314 (such as sports, music, math, etc.) identified via the profile of the user. In another example, the profile application may generate a pre-model of the user's doll, avatar or pet having appearance features based on favorites 316 (such as color, food, animal, etc.) identified via the profile of the user.

The profiler application may interface, communicate or otherwise provide the profile and/or pre-model to the creation application. In some embodiments, the profiler application may provide a file to the creation application 308 regarding the profile of the user. In some embodiments, the profiler application may make application programming interface (API) calls and/or interface to the creation application to create the pre-model of the user's doll. In some embodiments, the profiler application stores the profile and/or pre-model of the user to a database, accessible by other functionality of the website, such as the creation application. In some embodiments, the system or web application does not include a profile or user profile and the user creates a doll via the creation tool from a blank, default or initial stage.

The user profile created by the profiler may be used to customize and target the user's experience on the website from virtual doll building to online community interaction. Based on the user profile, the web application may customize or personalize web pages, content and interaction to be specific to or otherwise target the user. The user profile may be used to generate suggestions, recommendations or tips during the virtual doll building process for makeup, clothing and/or accessories. The user profile may used to customize or personalize any interactions in an online community, such as speech or text based communications from an avatar to another avatar or the user. For example, the web application may have an avatar communicate to the user about an interest specified by the user profile. In another example, the web application based used stored data from the user profile or avatar to generated and use speech based on that data, such as the avatar talking to the child about their interest such as sports.

The creation application 308, sometimes generally referred to as a creation tool or virtual doll builder, may comprise an application, program, library, script, process, services, task or other types and forms of executable instructions executable on a device. The creation application 308 may be a stand-alone program, a downloadable program, etc. In some embodiments, the creation application 308 may be a hyperlink to another website. The creation tool may include any type and form of graphics engine to render a virtual doll or avatar as described herein. The creation tool may comprise functions or operations for a user to customize the appearance and characteristics of any entity under design including but not limited to a doll, avatar or pet. The creation tool may be designed and constructed to provide a design tool or design wizard interface to guide a user through selection and configuration of the customizable characteristics of the entity under design. The creation tool may be designed and configure to assist a user in creating the entity under design. The creation application 308 may generate a pre-model of the user's doll, avatar or pet having appearance features based on the profile of the user. The creation tool may use one or more templates as starting points for the user to customize the doll, avatar or pet. Although the functionality and operations of the creation tool may be generally discussed below in terms of a virtual doll, the functionality and operations of the creation tool may be used for and apply as well to virtual pets, avatars and any other entity under consideration. The creation tool may provide a user interface by which the user selects the entity to design such as selecting between a doll, pet or avatar. The creation tool may provide creation screens or options based on the user's entity selection.

The creation application 308 may provide a user interface for the user to manipulate one or more of the following: outfit, accessories, name, birthday or room. The creation application 308 may provide a user interface for a user to select, configure or change any one or more of the following: the skin color, the hair color, the eye color, the shape of a feature, or the size of a feature of the user's doll, and the doll's speech such as via a speech chip. In some embodiments, the user may select from a predetermined set of speech to program into a speech chip of the doll. In some embodiments, the user may be able to record or otherwise provide the audio to program into a speech chip of the doll.

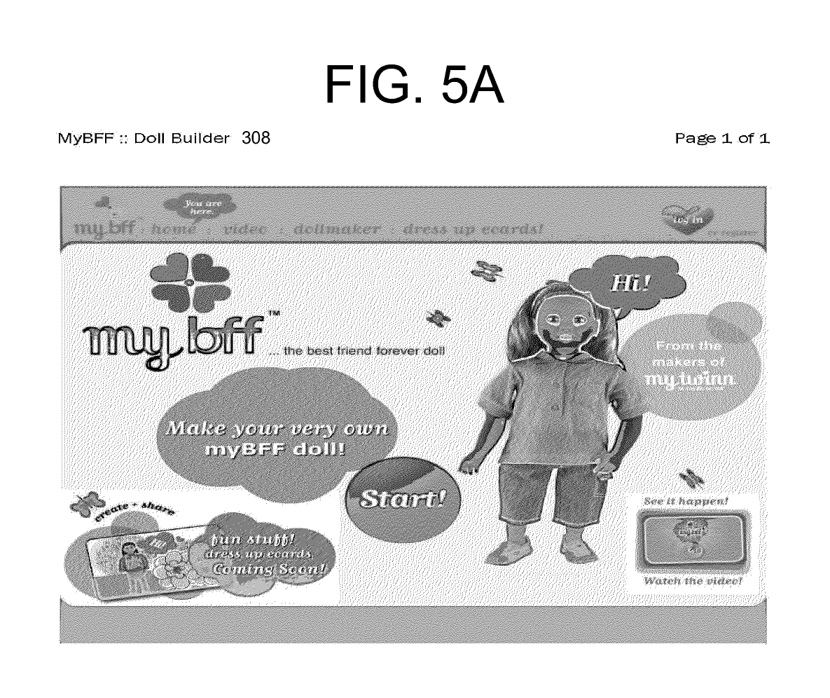

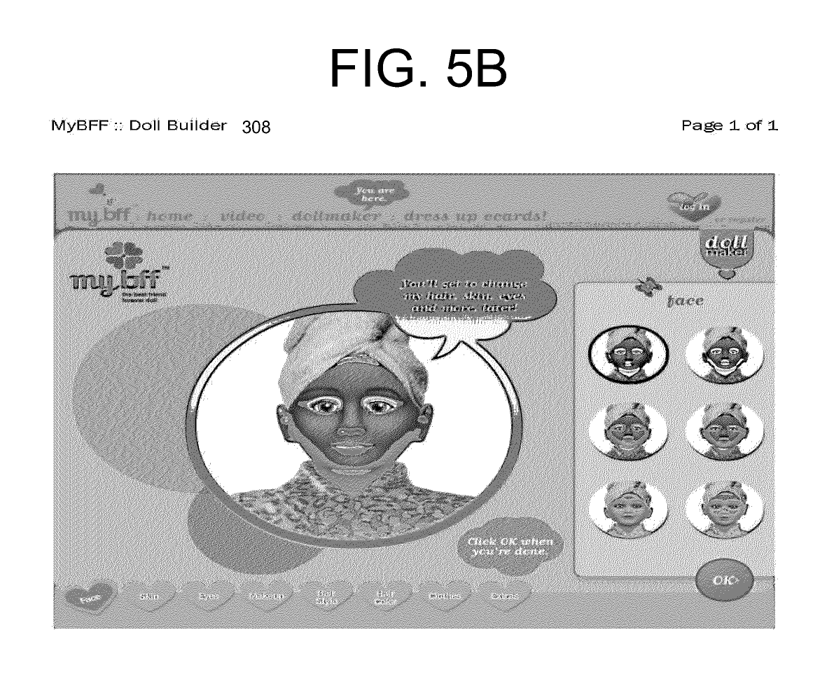

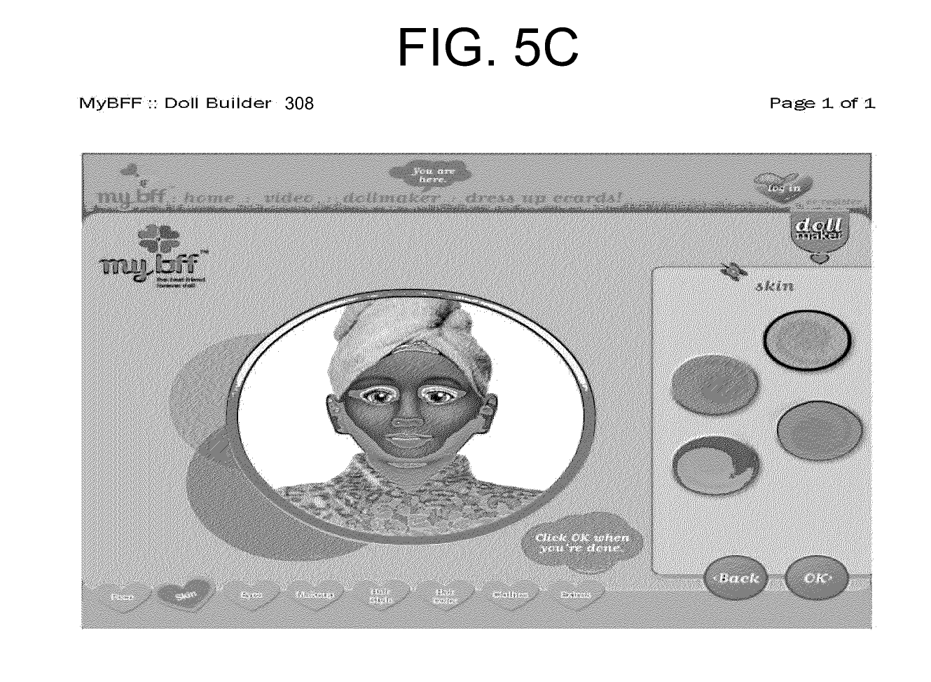

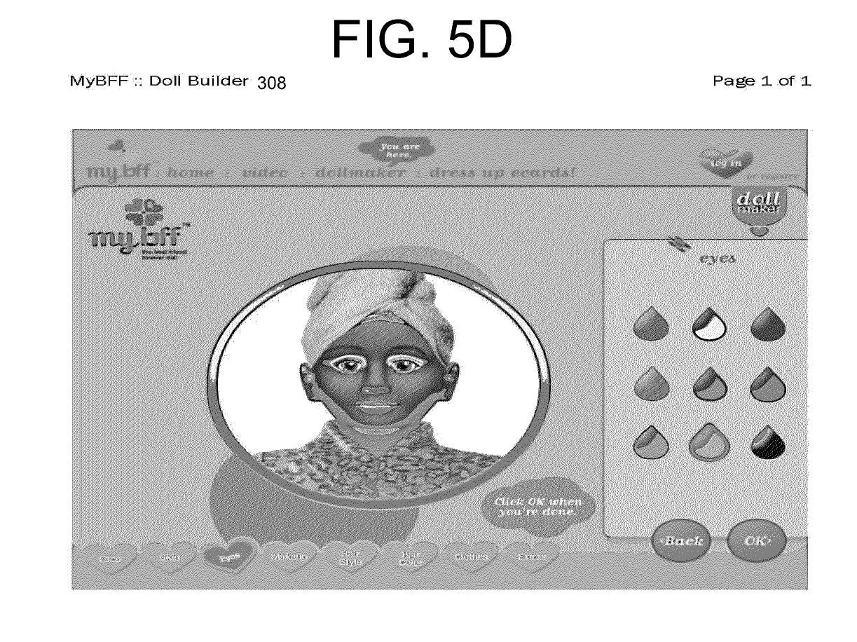

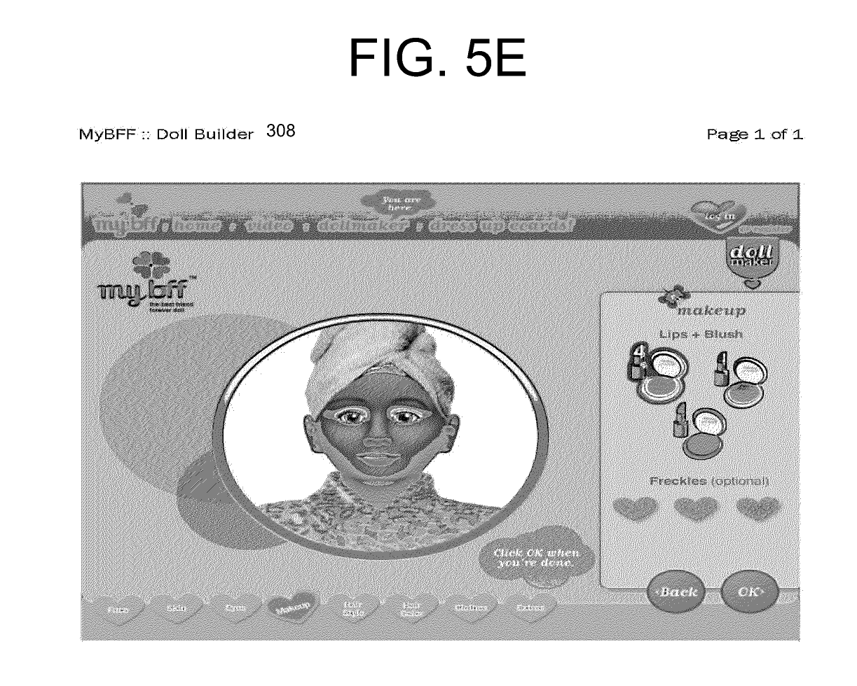

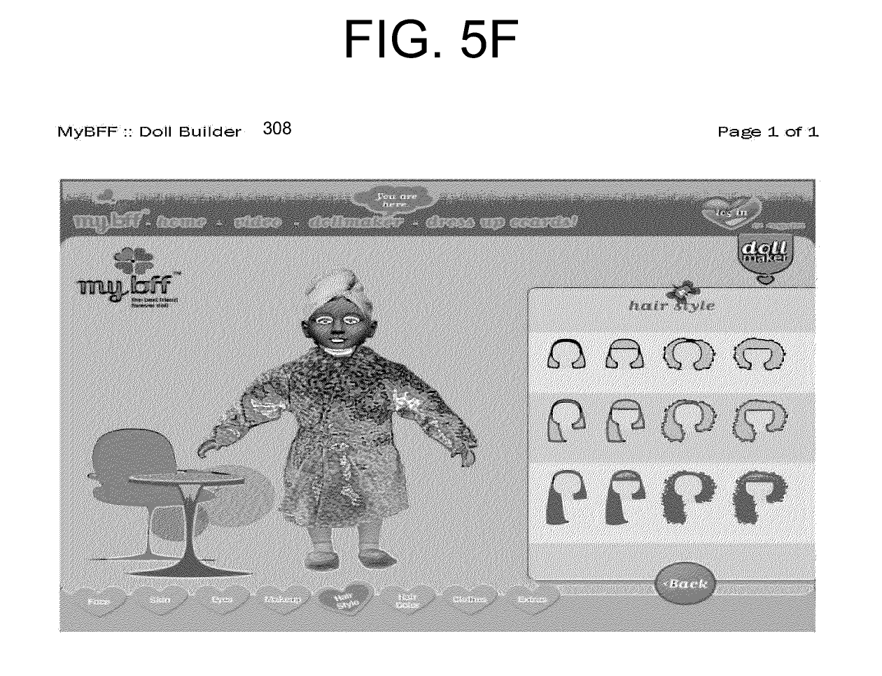

The creation application 308 may provide a user interface for the user to change a dimension or characteristic of the doll's head, face or features of the face or head. The creation application 308 may provide a user interface for the user to change a dimension or characteristic of body parts of the doll. In some embodiment as illustrated in FIG. 5B, the creation tool may provide user interfaces for a user to select, configure and/or customize each of one or more of the following: face, skin, eyes, makeup, hair styles, hair color, clothes and extras (and speech) (e.g., accessories). The creation tool may include a dress-up component or components in which the user can dress up the doll with a variety of selectable clothes and/or accessories. The creation tool may include a palette or selection of variety of fashion, clothes and accessories the user can arrange on, display on or otherwise include as part of building the virtual doll. The dress-up component may be designed and constructed to develop, design, make and/or select one or more wardrobes for the doll. The dress-up may include any type and form of shirts, blouses, suits, pants, skirts, belts, hats, jackets, sweaters, t-shirts, socks, underwear/garments, leg wear, shoes, jewelry, hair accessories, tattoos, glitter, etc.

In some embodiments, the creation application 308 displays a rendering of a user's doll, avatar or pet during the design and customization process. In some embodiments, the creation application 308 displays a rendering of a user's doll, avatar or pet upon a completion of the design and customization process. In some embodiments, the creation application 308 displays a rendering of a user's doll, avatar or pet based on the user's selection and configuration via the creation application. As the user changes and select options for the user's doll, avatar or pet, the creation application displays a rendering of the user's doll, avatar or pet based on the current selections. Upon the user completing the design process for the user's doll, avatar or pet, the creation application displays a rendering of the user's doll, avatar or pet based on the completed user selections. The creation application may provide a WYSIWYG interface (What you see is what you get). The creation application may provide a facsimile of the user's doll, avatar or pet based on the user's selection. The creation application may provide an avatar or other graphical representation of the doll based on the user's selection.

The creation tool may include a plurality of screens, steps or options for designing or customizing a user's doll, avatar or pet. In some embodiments, the creation tool wizard, guide or workflow may lead a user through a sequence of screens, steps or options. The user may follow this sequence in order. However, in some embodiments, the creation tool may provide flexibility in the user to follow these screens, steps or options in any order, including skipping over options or going back to options. For example, if the creation tool provides a twenty-five step configuration process, the user can complete any steps 1-25 and then go back to a step, such as step 5 to change an option. In another example, the user may skip any plurality of steps and complete the configuration process. In another example, the user may initially skip an option such as step 10 and then go back later to make a selection at step 10. In another example, the user may go backwards in the creation process starting at or near an end step and working backwards. In another example, the user may move forward via any one or more intermediate steps, such as steps 2-5 and then work backwards on another set of intermediate steps such as steps 12-9.

In some embodiments, the user profile may be used for filtering selections of the user via the creation tool. In some embodiments, preferences of the user may impact or filter options the user may have for configuring or customizing a virtual doll, avatar, pet or other entity. For example, the profile may filter the selection of clothes and/or accessories available to the user. If the user profile indicates a preference for sports, then the clothing and/or accessories may be filtered to initially display sports related, appropriate or themes clothing and/or accessories. In a further example, if the user profile indicates a preference for sports, then the hair style options may be filtered or limited to hair styles suitable for an active or sports playing doll. The user profile may used to personalize or customize any of the creation screens and options presented via the creation tool. The user profile may used to personalize or customize any search functionality of the system. For example, preferences from the user profile may used for filtering search capabilities and functions.

The creation tool may include a save function or operation to allow the user to save the virtual doll, avatar or pet the user is building or has built. The creation tool may save the virtual doll, avatar or pet in any type and form, such as data stored in a database or data stored in an object or data structure. Any time during the virtual building process, the user may select a save function (which may be represented via a selectable user interface element) to save the virtual doll, avatar or pet. The user may save the virtual doll, avatar or pet to retrieve the saved doll, avatar or pet at a later time to continue creating or customizing the doll. The user may save a purchased virtual doll, avatar or pet. In some embodiments, the web-application may automatically save a purchased virtual doll, avatar or pet. In some embodiments, the creation tool may automatically save a version of the virtual doll, avatar or pet as the user uses the creation tool. In some embodiments, the web application and/or creation tool may save a history of virtual dolls, avatars or pets that the user has created and/or purchased.

By saving the virtual doll, avatar or pet, the web application enables the use of the virtual doll, avatar or pet in any type and form of communication, including emails, electronic post cards, photos, physical post cards, print outs, letters, images, etc. In some embodiments, the creation tool provides an interface for the user to send an image of the virtual doll, avatar or pet, or a link to the virtual doll, avatar or pet on the website, to another user. In some embodiments, the creation tool provides an interface for a user to print an image or photo of the virtual doll, avatar or pet to paper format or to an electronic format, such as a portable document format (PDF) or image format. In some embodiments, the creation tool provides an interface for the user to create and send an electronic type card, greeting card or ecard that includes an image, picture or photo of a virtual doll, avatar or pet. The creation tool may include any type and form of designer for adding background, images, borders, themes, items and other elements as the user may desire to create the desired electronic or print form of the communication. The creation tool may include a dress-up component or designer to place, include clothing and/or accessories on the virtual doll, avatar or pet for the communication, such as an ecard.

The creation tool may save any of the user's options, selections or configuration of the virtual doll, avatar or pet to a user profile. The user profile may be used after the user has completed the customization of a doll or after the purchase of a doll customized by the user. For example, the virtual doll data may be used for sending emails, ecards, printing photos and participating in an online community. In some embodiments, the virtual doll, avatar or pet data of the user profile may be used for avatar based speech or text communications in an online community, such as a game or social networking or to decorate the avatar's virtual room.

In some embodiments, the web application and/or creation tool includes an option to purchase a saved virtual doll, avatar or pet based on data stored via the web application and/or creation tool. A user may retrieve any saved virtual doll, avatar or pet, such as to display and manipulate in the creation tool. Via the creation tool, the user may select any clothing and/or accessories to display on the doll, such as to see how these clothing and/or accessories look on the virtual doll, avatar or pet before making a purchase via the website for such clothing and/or accessories. Via the creation tool, the user may change the clothing and/or accessories that were on the saved version of the virtual doll, avatar or pet. Once the user has identified the desired clothing and/or accessories, the user can order and purchase these clothing and/or accessories for their virtual doll, avatar or pet.

In another aspect, the web-application and/or creation tool may include a makeover option for an already purchased doll. In makeover mode, the user may configure via the creation tool how they may want to change the doll they already have. The user can order and purchase a makeover for the doll via the web application and/or creation tool. For example, the user may want to change the hair color, hair style and/or makeup of the doll they already purchased. The web application and/or manufacturing of the doll may provide a doll hospital or doll makeover center for users to send, ship, return or deliver their purchased dolls for a desired makeover. The doll hospital may receive the desired makeover from the creation tool, such as in the same manner that the user sends the virtual doll configuration for initial manufacturing and purchase. The doll hospital may change the doll according the specifications of the makeover configuration. The doll hospital may retrofit, repair, service or otherwise reconfigure or remanufacture the doll to match or correspond to the makeover specifications. The makeover doll is shipped, returned or delivered back to the user or another intended recipient.

Further to the makeover aspect, a user may retrieve the saved virtual doll corresponding to their purchased doll. Via the creation tool, the user may select from any of the categories and options to change the appearance of the doll, which may include but is not limited to changing the face shape, hair style, hair color, eye shape, eye color, makeup, clothing and accessories. Once the user has a desired configuration, the user may select and order a makeover service or package via the purchasing interface. The manufacturing interface may send any data, information and/or specifications on the makeover configured by the user to the doll hospital. The web application, such as via the purchasing interface, may provide order and shipping information to the user for the user to send and track the delivery of the doll to the doll hospital. The web application, such as via the purchasing interface, may provide order and shipping information to the doll hospital for the doll hospital to track and manage the order, the receipt of the doll, the makeover service to the doll corresponding to the specifications of the makeover and delivery back to the user for the order.

The purchase interface 306, also referred to as an ordering interface, may provide any type and form of interface for a user to add or order items for purchase. The purchase interface may include any type and form of shopping cart functionality for adding, editing or otherwise managing items to purchase in an electronic shopping cart. The purchase interface may include a user interface for a user to select one or more customized, configured or designed dolls and/or avatars to add to a shopping cart. The purchase interface may include a user interface for a user to select one or more customized, configured or designed avatars or virtual pets to add to a shopping cart. The purchase interface may include a user interface for a user to select one or more accessories or other related site items to add to a shopping cart. The purchase interface may include an interface for receiving, identifying or otherwise processing any type and form of financial information to make the purchase, such as credit card information, bank information, check information, PayPal, etc. The purchase interface may include an interface for executing the purchase via transactions with one or more financial sources, such as a bank processor, payment processor, credit card company, bank, etc. The purchase interface may include an interface for shipping the purchase via any type and form of shipper, and track and provide information on the shipment status to the user.

The purchase interface may be designed and constructed to allow a child or minor to purchase a doll, avatar, pet or item they created with the help of a parent. For example, the child may select a user interface element of the website to indicate the child wants to purchase the doll, avatar, pet. The website may send an email to the parent (email may be part of website account or added or provided by the child). The email to the parent may include a link for the parent to see and complete the purchase.

The purchase interface 306 may include a signal or visual indicator to the user that a doll, avatar or pet the user is designing or has designed is ready for purchase. For example, a button may be included on the interface that the user can select in order to purchase the doll, avatar or pet or an avatar. This button may be enabled when a doll, avatar or pet has been designed to a predetermined point or has otherwise been completely configured. The purchase interface 306 may include the price of the doll, avatar or pet with or without certain preferences. For example, the addition of glasses may increase the price of the doll, avatar or pet, which may be reflected on the purchase interface. The purchase interface 306 may receive a request to purchase the user's doll, avatar or pet created via the website server application 234. In some embodiments, the purchase interface may connect the user interface to another system, device or application for handling and/or processing the purchase transaction. The purchase interface, device or application may log sales, process orders, track inventory, etc.

In another aspect, the purchase interface may provide any type and form of system or methods for prepaid monetary value or credits. In some embodiments, the web-application and/or purchase interface allows a parent to provide a prepaid amount that a child or other user can spend on purchasing a doll, virtual characters or property, clothing, accessories and or any other item that may be made available for purchase, including real and virtual property. For example, a parent may preload a certain amount of credits into the purchase interface. In another embodiment, the web application or provider of the system may provide a preloaded debit or credit card that a user may use for purchases. This card may be an affinity based card associated with the brand or the provider of the website. In some embodiments, the parent may set a limit in the purchase interface on the amount a child may purchase. This limit may be set as a total amount for a single purchase or for a plurality of purchases. This limit may be a set amount to spend on a per month basis or other frequency. In this manner, the child can make purchases without further permission from the parent while the parent has control and limits on the spending.

The web application may comprise, integrate, interface or otherwise communicate with a manufacturing interface 304 to communicate to one or more manufacturing facilities, site, department, manufacturers or otherwise an entity that will create a doll, avatar or pet in accordance with the customized, designed or configured doll, avatar or pet purchased via the web application. The manufacturing interface may include any type and form of communication means, protocol, schemes to send, receive and/or exchange information between the web application and entity manufacturing the doll. The manufacturing interface may communicate such information responsive to the purchase interface, such as upon completion of a purchase of a doll, avatar or pet by a user.

The entity manufacturing the doll may build the doll according to the virtual doll specifications or rendering provided by the web-site and creation tool via the manufacturing interface. The manufacturer may have components corresponding to each doll element the user may select and customize via the creation tool. For example, the manufacturer may have doll heads corresponding to each of the face types selectable via the creation tool. The manufacturer may have doll heads and body parts corresponding to each of the skin types selectable via the creation tool. The manufacturer may have eye components to the doll corresponding to each of the eye colors selectable via the creation tool. The manufacturer may have doll heads corresponding to any combination of face type, eye color, skin type, makeup and/or freckles selectable via the creation tool. The manufacturer may have hair components to the doll corresponding to each of the hair styles and/or hair colors selectable via the creation tool. The manufacturer may use any type and form of manufacturing to build the doll. Based on the specification of the user's doll via the creation tool, the manufacture may use these components to build a doll corresponding to the customization and rendering of the user's doll via the creation tool.

The manufacturing interface 304 may convert, translate or process the customization, configuration and/or design of the doll, avatar or pet from the web application into instructions, files, data and/or information for the doll, avatar or pet to be manufactured. For example, the manufacturing interface may communicate or otherwise provide a specification on the doll as purchased by the user via the web application. The manufacturing interface may determine inventory, available manufacturing services, available materials, turn-around time, cost of specific parts, labor or services, etc. In some embodiments, the manufacturing interface 304 may display these determinations via the user interface. For example, the user interface may display that the doll will be ready in “7-10 business days.”

Any of the web application, creation tool, profiler, purchase interface and/or manufacturing interface, or any portions thereof, may be designed and constructed or otherwise implemented in a form of a mobile application, generally referred to as an app, that executes on any type and form of mobile device, such as for example a smartphone, iPad, iTouch, blackberry, tablet, etc. The app may be designed and constructed for any type and form of operating system of the mobile device. In some embodiments, the app is a companion app and working in conjunction with the web application. The app may provide all of the same functionality of the web application, creation tool, profiler, purchase interface and/or manufacturing interface. A user can create and order a virtual doll and/or avatar via a mobile application without going to a website and interface with an online community via the application on the user's mobile device. In some embodiments, the user can perform some of the functions via the website and other functions via the mobile app. For example, the user may create a virtual doll on the website and order and purchase the doll via the mobile. In another example, the user may create and purchase a virtual doll via the mobile app and then participate in an online community via the website.

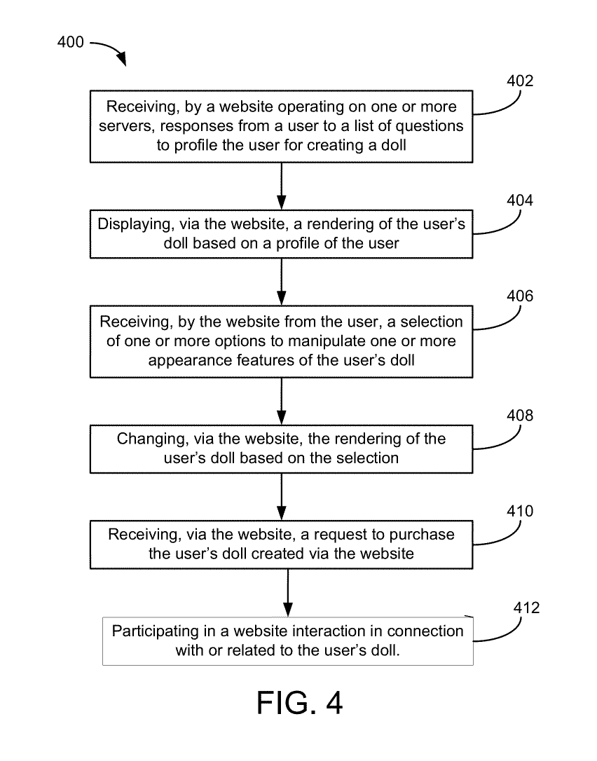

Referring to FIG. 4, a flow diagram of a method in accordance with a described embodiment is shown. The method 400 is provided by way of example, as there are a number of ways to carry out the methods according to the present disclosure. The method 400 shown in FIG. 4 may be executed or otherwise performed by a variety of systems. The method may be implemented by a computer, a computer program, a client, a server, a client-server relationship, etc. The method 400 is described herein as carried out by the system of FIG. 3 by way of example. Although, at times, embodiments of this method may be described in connection with a virtual doll, steps of this method may be used for avatars and/or pets in combination with or separate from a virtual doll. As such, the user may create and purchase, alone or in any combination, a doll, pet or avatar.

In brief overview of method 400, at step 402, the web application may receive responses from a user to a list of questions provided to the user for creating a doll. At step 404, the web application may create or establish a pre-model of a doll based on a generated user profile. At step 406, the user selects one or more options to customize the appearance of the doll. At step 408, the web site displays or renders the doll based on the user's selection. At step 410, the user purchases the doll via the web site. The doll is manufactured according to the doll designed from the web application and the manufactured doll is shipped to the user.

In further details, at step 402, a user profile is generated such as from responses by a user to a list of questions to profile the user, such as for the basis of creating a doll for the user. The user profile may be generated to identify or include favorites, preferences or attributes of the user. In some embodiments, the web application provides a user interface for soliciting or receiving input from a user, such as to a predetermined set of favorites, preferences or attributes. In some embodiments, the favorites, preferences or attributes from a user may be received via a questionnaire. In some embodiments, the favorites, preferences or attributes from a user may be received by a survey. In some embodiments, the favorites, preferences or attributes from a user may be received from an email, a text message, etc. In some embodiments, the favorites, preferences or attributes from a user may be received from a third party application, such as Facebook, Google+, etc. In some embodiments, a list of questions to obtain the user's favorites, preferences or attributes are communicated via the website to the user to provide guidelines to model the user's doll. In some embodiments, the list of questions are communicated via a third party application, such as Facebook, Google+, etc, to the user. In some embodiments, the list of questions are communicated via an email, SMS, MMS, etc.

The web application may generate a user profile in any type and form, such as data stored in a database, file or cookie. In some embodiments, the user profile may be stored in memory and/or any type or form of object or data structure. The user profile may be created and stored in associated with the user's account on the website.

In some embodiments, steps 402 and 404 may be not be performed. The web application and methods described herein work without profiling and/or generating a user profile. In some embodiments, the system provides options for the user to start building a doll, an avatar or a pet. In some embodiments, the user may build an avatar without building a doll and purchase the avatar. In some embodiments, the user may build and purchase a doll and build, obtain and/or purchase an avatar. The user may get the avatar for free with the doll or may have to pay also for the avatar. In some embodiments, the user may build and purchase alone or in any combination, a doll, avatar and pet.

At step 404, the web application, such as via the creation tool, may generate an initial rendering of a doll, avatar or pet. In some embodiments, the web application generates a rendering of a doll, avatar or pet for the user based on a profile of the user, such as the user profile generated via step 402. In some embodiments, the web application generates a rendering of a doll, avatar or pet for the user based on preferences of the user. For example, if the user prefers sports, then a sports theme, configured rendering of a doll, avatar or pet may be rendered. In some embodiments, the web application generates an initial or default rendering of a doll for the user to start a doll building process. For example, the creation tool may not use a user profile and provide a default or blank doll for the user. In some embodiments, the web application via the creator tool and responsive to the user profile may provide, generate or render a pre-model or initial model for a doll. In some embodiments, the rendering of the user's doll may be based on one or more of the preferences, favorites and/or attributes in the user profile. In some embodiments, the rendering of the user's doll may be based on default settings. In some embodiments, the rendering of the user's doll may be based on a pre-defined template. For example, the user may skip the questions and simply choose a “sports-themed” doll.

At step 406, the user via the creation tool may configure, customize and/or design the doll, such as the pre-model or initial design from step 404. The user may use the design elements of the creation tool to change, manipulate or configure a plurality of appearance features of the doll, including but not limited to face shape, skin color, eye shape, eye color, lip shape, lip color, hair style or cut, hair color, nose shape, ear shape, etc. The user may use a selection of one or more options via the creation tool to manipulate one or more appearance features of the user's doll. In some embodiments, the user may select one or mote buttons from a predetermined set of options for each customizable feature of the doll. For example, the user may select one desired face shape from a plurality of face shapes made available via the creation tool. In some embodiments, the user may change the selection of one or more options from a previous selection to a new selection.

At step 408, responsive to the user's design via the creation tool, the web application may change the rendering of the doll based on the current design, configuration or selection. The creation tool and/or web application may display a new rendering of the doll responsive to each user' selection via the creation tool. The creation tool and/or web application may display a new rendering of the doll responsive to a set of multiple selections via the creation tool. The creation tool and/or web application may display a new rendering of the doll responsive to the completion of the design of the doll. The creation tool and/or web application may display a new rendering of the doll responsive to each users request to update the rendering of the doll. In this manner, the user may see the changes to the doll based on the user's current selection or changes to the current selection. In some embodiments, the user may roll over the selection to view the change. For example, the user may hover over a selection to temporarily view the change on the doll, but may click on the change to permanently select the change.

At step 410, a user may select, order and purchase the doll and/or avatar the user created via the creation tool/web application. In some embodiments, the user places the created doll into a shopping cart and then may check out of the shopping cart to confirm billing, shipping any other order processing information. Upon confirmation of purchase, the web application may communicate to manufacturing a specification or other information to build the doll in accordance with the user's design. Based on the design of the doll, the doll manufacturer may create or manufacture a physical doll to have the same appearance features as created via the creation tool/web application. In some embodiments, the doll is manufactured to have the same look, features or options as the user designed, configured or selected via the web application. In some embodiments, the doll is manufactured to a different scale of the doll as rendered or displayed via the web application. In some embodiments, the physical doll is manufactured to look substantially the same as the rendering of the designed doll or virtually created doll via the web application. Upon completion of manufacturing, the physical doll is shipped to the user or to a shipping address specified by the user.

In further details at step 410, the user may purchase alone or in combination, any of the doll, avatar and pet. For example, in some embodiments, the user creates a virtual doll for manufacturing and purchases the virtual doll and gets or purchases an avatar.

At step 412, the user may participate in community or other website interaction in connection with or related to their created doll. The web application may create an avatar or other graphical representation of the doll created by the user for the user's account on the website. The user may interact via the avatar with various social community aspects of the website, including games, activities, etc. The user may interact with other users and their avatars via the website. In some embodiments, the user may engage in games or other related activities online with their doll. In some embodiments, the user may link their doll with their social networking site. The user may also create a social networking page for their doll. The page may include a newsfeed relating to the doll, other promotions, opportunities, etc.

Referring to FIGS. 5A-5F, a website in accordance with described embodiments is shown. The website may include one or more hyperlinks to various web pages. For example, the hyperlinks may direct the user toward a video, e-card, chat applet, doll maker, etc., as shown in FIG. 5A. The web application may comprise a plurality of screens such as those shown in FIGS. 5B thru 5F that provide a creation tool 306 for the user to design, configure and customize the doll. This may be referred to a creation wizard or doll designer.

Referring to FIG. 5A, the website may direct the user to create their very own “my best friend” (myBFF) doll. A start button or other user-friendly icon will direct the user to begin the process.

Referring to FIG. 5B, the user may select the shape of the face of the doll. The user may select a face shape from a plurality of shape faces provided by the creation tool. After the user selects a face for the doll, the current image of the doll will change to reflect the user's selection. The user may then click another button, touch the screen, etc. to advance to another selection.

Referring to FIG. 5C, the user may select the skin color for the doll. The user may select a skin color from a plurality of skin colors provided by the creation tool. After the user selects the skin color for the doll, the current image of the doll will change to reflect the user's selection. The user may advance to another selection, may edit previous selections, exit the doll maker, or purchase the doll at any time.

Referring to FIG. 5D, the user may select the eye color for the doll. The user may select an eye color from a plurality of eye colors provided by the creation tool. After the user selects the eye color for the doll, the current image of the doll will change to reflect the user's selection. The user may advance to another selection, may edit previous selections, exit the doll maker, or purchase the doll at any time.

Referring to FIG. 5E, the user may select the makeup for the doll. As shown in FIG. 5E, the makeup may include blush, lipstick, and/or freckles. The makeup may include mascara, eye shadow, glasses, eyebrow shapes, perfume-scented doll, etc. After the user selects the makeup for the doll, the current image of the doll will change to reflect the user's selection. The user may advance to another selection, may edit previous selections, exit the doll maker, or purchase the doll at any time.

Referring to FIG. 5F, the user may select the hairstyle for the doll. The user may select a hair style from a plurality of hair styles provided by the creation tool. After the user selects the hairstyle for the doll, the current image of the doll will change to reflect the user's selection. The user may advance to another selection, may edit previous selections, exit the doll maker, or purchase the doll at any time.

In an example embodiment of the systems and methods for virtual doll building, the website may direct the user to a list of questions to create a profile. In some embodiments, the website may have a number of default dolls for the user to select. In some embodiments, the website may allow the user to skip the list of questions and create a doll based on the pre-existing categories with their respective features. For example, the user may have a default doll and scroll though the categories to create a doll. The categories may include skin color, shape of face, size of face, hair color, hair style, eye color, eye shape, makeup, outfit, shoes, accessories, room, etc. The selection within each category may be made by a single click, a double click, dragging and dropping, touching, etc. The user may also modify the doll created from their profile. The user may navigate from one category to another and go back and forth until the doll that they want to purchase is created. In some embodiments, the doll is saved after each modification. In some embodiments, the user may enter the name, birth date, etc. of the doll.

The user's doll may be created from a list of questions, survey, email, etc that has been provided to the user. For example, “What is your favorite sport?” may be one of the questions. If the user responds with “soccer,” then the user may choose a soccer outfit as an additional purchase, outfit the doll in a soccer uniform, or decide to choose a different sport or outfit. In some embodiments, the list of questions may be asked as the user creates the doll.

The website may include a summary of everything that the user has selected for the doll. The summary may also provide a price total. In some embodiments, the summary may be printed. In some embodiments, the summary may be downloaded or saved. In some embodiments, the summary may be emailed. In some embodiments, the summary may allow the user to purchase.

The website may also include a tally of the cost of the doll and the additional selected features. The website may include a purchase button. The purchase button may only allow a parent's email address to be entered or other secure method to ensure that the parent has authorized the purchase.

With the multitude of options and permutation of combination of options available via the virtual doll builder of the systems and methods described herein, users may create millions and millions of different dolls, purchase such dolls and have any one of these millions of variations of the doll manufactured and shipped to the user. For example, the user may have the following N categories, which may change and grow, to select options from: face shape, skin color, eye color, makeup, hair color, hair style, clothes and accessories. For each or within each of these N categories, the user may be able to select from M possible choices, which may change and grow at any time. A user may select an option from one category or all N categories. Within each category, there may be a few options or hundreds or more options. As such, the great number of different combinations may be determined by statistical computation as N!/M!(N−M)!. Furthermore, with the vast number of permutations, a user may be able to design or build a virtual doll and corresponding manufactured doll that resembles, closely resembles or otherwise corresponds to a desired person, including themselves, friends, family, celebrities and any other person. In some embodiments, the user may be able to design or customize a virtual doll that is a twin of the user or a facsimile of the user years earlier (i.e., a 60 year old can re-create her likeness when she was 6 years old).

Although the systems and methods described herein may be generally described for virtually building a custom doll that may be manufactured and shipped to the user, the systems and methods herein may be used for any other type and form of entity or thing, including but not limited to avatars, pets, custom toy figures, etc, including entities to be manufactured and/or entities to exist virtually online. The creation tool may be adapted, designed and/or constructed to support the configuration, customization and design of the entity under consideration. As such, the screens, steps or options to use may be designed and adapted according to the entity to be created.

For example, in some embodiments, a creation tool may be designed and constructed to be a virtual pet builder. In these embodiments, the creation tool may include options to select the type of pet, such as dog, bird, cat, reptile, fish, etc. The creation tool may include options for the user to select options on the appearance of the pet, including but not limited to the size, shape and color of any features of the pets including face, eyes, skin, fur, claws, beak, tail, fins, ears, tongue, feet, paws, etc. In some embodiments, the creation tool provides a virtual pet for the user to user online in a community. The virtual pet may be a companion to a virtual doll or avatar that the user has created. As such, the website and online communities may be adapted, design and constructed for the virtual pet to participate, interact and/or otherwise communicate online, such as in one or more online communities. In some embodiments, the user may able to order and purchase the virtual pet to use online. In some embodiments, the user may be able to order and purchase a manufactured toy pet or stuffed animal pet corresponding to or matching the likeness of the virtual pet. Much like the user can purchase a manufactured doll based on the user's doll specifications via the creation tool, the user can purchase a manufactured pet toy, figurine or doll based on the user's pet specifications via the creation tool.

For example, in some embodiments, a creation tool may be designed and constructed to be an avatar or virtual online persona builder. In these embodiments, the creation tool may include options to select any type of gender, creature or character for the avatar. The creation tool may translate a virtual doll or virtual pet to an avatar. The user may change or further configured the translated avatar. The creation tool may include options for the user to select options on the appearance of the avatar, including but not limited to any of options discussed herein for a virtual doll and/or virtual pet. In some embodiments, the creation tool provides an avatar for the user to user online in a community. The avatar may be a companion to a virtual doll or virtual pet that the user has created. As such, the website and online communities may be adapted, design and constructed for the avatar to participate, interact and/or otherwise communicate online, such as in one or more online communities. In some embodiments, the user may able to order and purchase the avatar to use online. In some embodiments, the user may be able to order and purchase a manufactured replica of the avatar, such as a figurine or stuffed toy corresponding to or matching the likeness of the virtual pet. Much like the user can purchase a manufactured doll based on the user's doll specifications via the creation tool, the user can purchase a manufactured avatar based on the user's avatar specifications via the creation tool.

The systems and methods of embodiments of the present solution provide a further rich user experience by enabling and providing online social and community based interactions via one or more avatars of the user. The present solution may provide a rich user experience around the virtual doll building theme by establishing a doll related community and online experience, such as for social networking and multi-player gaming. The system may leverage the user profiles to customize and personalize communications of the avatar or the system to the user. The system may leverage the user profiles to target content, media, games, activities to each of the users.

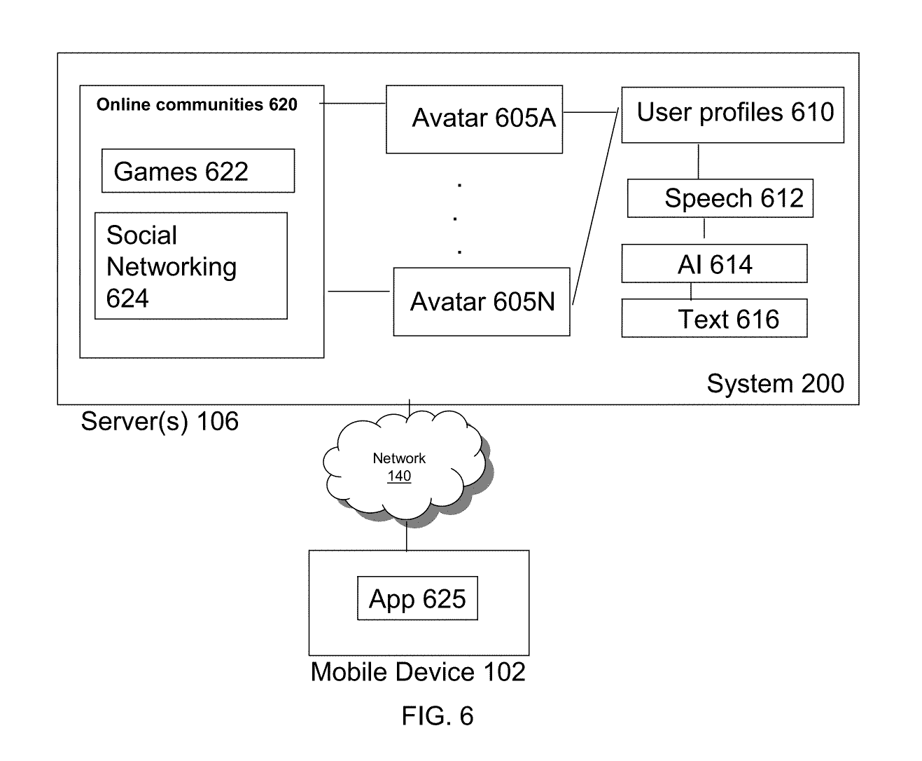

Referring now to FIG. 6, an embodiment of a system for providing online communities for the users to interact via their avatars is depicted. In brief overview, the system 200 may generate one or more avatars 605A-605N (generally referred to as avatar 605) for each user. Based on the user profiles 610, the system may personalize or customize the interaction with, to, from or between avatars 605. The system may provide personalized or customized speech communications 612 and/or text communications 616. The system may direct, control or customize the behavior of the avatars using artificial intelligence 614. The users, via the avatars, may participate in or interact in one or more online communities 620, which may include social networking 622 and games 624, such as multi-player games. A mobile application 625 on a mobile device may be used by the user to interact with the system, such as with an avatar or in an online community.

The creation tool may translate, convert or transform any virtual doll, pet or other entity into one or more avatars for the user. In some embodiments, the system generates an avatar based on the user profile 610. In some embodiments the system generates an avatar from or based on a saved virtual doll, a saved virtual pet or other virtual entity. In some embodiments, the avatar is a scaled or graphical representation of a virtual doll. In some embodiments, the avatar is a scaled or graphical representation of a virtual pet. In some embodiments, the user creates or generates an avatar using an avatar builder provided by the creation tool of the system. In some embodiments, the user is able to create or generate an avatar the resembles the likeness of the user. In some embodiments, the user modifies an avatar generated by the system using the avatar builder of the creation tool. In some embodiments, the system creates or generates an avatar based on an image or photo of the user.

The system may be designed and constructed to communicate to the user via an avatar of the user. The system may personalize or customize any type and form of text, audio, graphical or video communications via the avatar to the user. In some embodiments, the system may personalize or customize communications based on the user profile 610. In some embodiments, the avatar may be designed and constructed to speak. The system may have the avatar use speech 612 to communicate to the user about any interests identified in the user profile. In some embodiments, the system may have the avatar use text communications 616, such as SMS texting, instant messaging or having a chat session with the user. In some embodiments, the system may convert text to speech for communications of the avatar. For example, a user may direct her avatar to speak in an chat or other text messaging session based on the text the user enters into the system.

In some embodiments, the system may use artificial intelligence 614, such as via an artificial intelligence engine, to direct the behavior of the avatar in the system, such as the behavior of the avatar in interacting with a user or in the online community. In some embodiments, the avatar may be designed and constructed to be animated or to change behavior and/or appearance. The artificial intelligence may control or direct the avatar to change the facial expressions of the avatar, such as to such emotions. The artificial intelligence may control or direct the avatar to change the position or orientation of the avatar. The artificial intelligence may control or direct the avatar to move any portion or part of the avatar, such as movement of head or limbs.

In some embodiments, the system may suggest or recommend activities, games or other users/avatars for the user to interact with or otherwise experience based on the user profile. In some embodiments, the system may suggest or recommend a sub-community in the online communities for the user to join or otherwise participate. In some embodiments, the system may generate, customize, personalize, suggest or recommend any content or media for the user to view.

The online communities may comprise any type and form of online resources such as a social network or discussion platform. Social networks may include any type and form of a website, or network of websites, established to allow end users to communicate directly with each other on topics of interest and/or mutual interest. Discussion platforms may include any type and form of a website, network of websites, or sections or portions of these websites that enable and provide for discussions between users on topic or topics of mutual interest. Social networks and discussion platforms may provide for user generated or user identified: topics, subject matter for discussions and/or discussion threads. Social networks and discussion platforms may store comments, questions, statements or other input generated by a user of the social network or discussion platform. The online communities may be organized based on preferences, favorites or attributes of user profiles. The user may interact via their avatars, virtual dolls or virtual pets in any of these online communities.

The online communities may be designed and constructed for multiple avatars to communicate and interact with each other. In some embodiments, an avatar may be able to communicate with other real life friends, such as via their avatars, in social networking portions of the site. In some embodiments, an avatar may be able to play with other real life friends, such as via their avatars, in multi-player games. In some embodiments, the games may be designed and constructed to include, display or have the avatar of the user within the game.

The online community may include a virtual world or community. The virtual world may include an online environment that comprises building structures (houses, etc), dolls, people, pets, etc in any type and form of living environment, including urban, suburban, farm or rural environments. In some embodiments, the virtual world may comprise one or more doll houses with one or more virtual dolls and/or virtual pets. The system may include any type and form of community building tools for a user to build components of the virtual world and to select virtual dolls, pets, avatars, etc. to include in the virtual world. The system may include any type and form of community or virtual world simulation for the virtual word to be dynamic, active and interactive and for elements of the virtual world to change, grow or evolve responsive to changes in the environment of the virtual world.

In some embodiments, the user profile is used to personalize or customize the virtual world. For example, based on any preferences, favorites or other attributes of the user in the user's profile, the system may suggest or recommend any elements or design in the virtual world, such as the decorations of a room or a style of the home or room in the home. For example, if the user prefers sports, a bedroom in the virtual world may include or display sports themed posters or memorabilia or trophies. In some embodiments, the system automatically generated or creates the virtual world or any components therein based on any preferences, favorites or other attributes of the user in the user's profile.

Embodiments of the systems, methods and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on one or more computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or may be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “client” or “server” includes all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display), OLED (organic light emitting diode), TFT (thin-film transistor), or other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific embodiment details, these should not be construed as limitations on the scope of any disclosures or of what may be claimed, but rather as descriptions of features specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of this application. In some cases, the actions can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

What is claimed:

1. A method for creating and purchasing a customized doll via a website, the method comprising:
(a) displaying, via the website operating on one or more servers, a rendering of a user's doll created by a user via the website;
(b) receiving, by the website from the user, a selection of one or more options to change one or more appearance features of the user's doll;
(c) changing, via the website, the rendering of the user's doll based on the selection; and
(d) receiving, via the website, a request to purchase the user's doll created via the website.

2. The method of claim 1, wherein step (a) further comprises displaying a pre-model of the user's doll having appearance features based on preferences identified via a profile of the user.

3. The method of claim 1, wherein step (b) further comprises communicating, via the website, a creation screen for the user to select options for one or more of the following: outfit, accessories, name, birthday or a room.

4. The method of claim 1, wherein step (b) further comprises receiving, via the website, a selection of one or more options to change a skin color of the user's doll.

5. The method of claim 1, wherein step (b) further comprises receiving, via the website, a selection of one or more options to change one of a hair color and hair style of the user's doll.

6. The method of claim 1, wherein step (b) further comprises receiving, via the website, a selection of one or more options to change an eye color of the user's doll.

7. The method of claim 1, wherein step (b) further comprises receiving, via the website, a selection of one or more options to change one of makeup or freckles of the user's doll.

8. The method of claim 1, further comprising manufacturing the user's doll corresponding to the rendition of the user's doll on the website.

9. The method of claim 1, further comprising generating, via the web-site, an avatar corresponding to the user's doll.

10. The method of claim 9, further comprising providing, via the web-site, an online community that the user can interact with via the avatar.

11. A system for creating and purchasing a customized doll via a website, the system comprising:
a website operating on one or more servers, the website providing a user interface for creating a doll by a user;
a creation tool to display a rendering of the user's doll;
wherein the creation tool receives a selection of the one or more options to change one or more appearance features of the user's doll and changes the rendering of the user's doll based on the selection; and
an ordering interface to receive a request to purchase the user's doll created via the website.

12. The system of claim 11, wherein the creation tool displays a pre-model of the user's doll having appearance features based on preferences identified via a profile of the user.

13. The system of claim 11, wherein the creation tool provides an interface for the user to select options for one or more of the following: outfit, accessories, name, birthday or a room.

14. The system of claim 11, wherein the creation tool receives a selection of one or more options to change a skin color of the user's doll.

15. The system of claim 11, wherein the creation tool receives a selection of one or more options to change one of a hair color and hair style of the user's doll.

16. The system of claim 11, wherein the creation tool receives a selection of one or more options to change an eye color of the user's doll.

17. The system of claim 11, wherein the creation tool receives a selection of one or more options to change one of makeup or freckles of the user's doll.

18. The system of claim 11, wherein the ordering interface communicates information on the user's doll to manufacture the user's doll corresponding to the rendition of the user's doll on the website.

19. The system of claim 11, wherein the web-site generates an avatar corresponding to the user's doll.

20. The system of claim 19, wherein the web-site further comprises an online community that the user can interact with via the avatar.
